(19) United States
(12) Patent Application Publication
(10) Pub. No.: US 2011/0187028 A1
(43) Pub. Date: Aug. 4, 2011

(54) Blow Molded Liner for Overpack Container and Method of Manufacturing the Same

(76) Inventors: Joseph Menning, Prior Lake, MN (US); Kirk Mikkelsen, Carver, MN (US)

(21) Appl. No.: 12/745,605

(22) PCT Filed: Dec. 2, 2008
(86) PCT No.: PCT/US08/85264

§ 371 Date: Feb. 15, 2011

Related U.S. Application Data
(60) Provisional application No. 61/012,224, filed on Dec. 7, 2007.

(51) Int. Cl. B29C 59/16; B29C 49/00; B29C 49/42; B29C 49/06; B29C 49/64; B29C 49/80; B29C 49/08; B65D 35/14; B65D 37/00; B65D 35/22

(52) U.S. Cl. 264/447; 264/523; 264/537; 264/513; 264/535; 264/40.1; 264/532; 53/396; 383/3

(57) ABSTRACT

The present disclosure relates to flexible, three-dimensional injection blow molded or injection stretch blow molded liners for use in overpacks, bottles, containers, etc. and methods for manufacturing the same. A method for manufacturing a liner may include injecting a polymeric material into a preform mold die to form a preform, blow molding the preform to form the liner, collapsing the liner and positioning the liner in an overpack, and inflating the liner. A fluoropolymer may be used for the preform. A liner may comprise a flexible body that substantially conforms to the interior of an overpack and a fitment port integral with the flexible body. The flexible body may be adapted to be removably inserted into the overpack by collapsing the flexible body, inserting the flexible body into the overpack, and re-inflating the flexible body inside the overpack. The flexible body may comprise a fluoropolymer and may comprise multiple layers.

### FIELD OF THE INVENTION

The present disclosure relates to liner-based storage and dispensing systems. The present disclosure further relates to liners for overpacks, bottles, containers, etc. and methods for manufacturing the same. More particularly, the present disclosure relates to flexible, injection blow molded or injection stretch blow molded liners for use in overpacks, bottles, containers, etc. and methods for manufacturing the same.

### BACKGROUND OF THE INVENTION

Numerous manufacturing processes require the use of ultrapure liquids, such as acids, solvents, bases, photoresists, dopants, inorganic, organic, and biological solutions, pharmaceuticals, and radioactive chemicals. Such industries require that the number and size of particles in the ultrapure liquids be controlled to ensure purity. In particular, because ultrapure liquids are used in many aspects of the microelectronic manufacturing process, semiconductor manufacturers have established strict particle concentration specifications for process chemicals and chemical-handling equipment. Such specifications are needed because, should the liquids used during the manufacturing process contain high levels of particles or bubbles, the particles or bubbles may be deposited on solid surfaces of the silicon. This can, in turn, lead to product failure and reduced quality and reliability.

Accordingly, storage, transportation, and dispensing of such ultrapure liquids requires containers capable of providing adequate protection for the retained liquids. Two types of containers typically used in the industries are simple rigid-wall containers made of glass or plastic and collapsible liner-based containers. Rigid-wall containers are conventionally used because of their physical strengths, thick walls, inexpensive cost, and ease of manufacture. Such containers, however, can introduce air-liquid interfaces when pressure-dispensing the liquid. This can cause gas bubbles to dissolve into the retained liquid, such as photoresist, in the container and can lead to undesired particle generation in the liquids.

Alternatively, collapsible liner-based containers, such as the NOWPak® dispense system marketed by ATMI, Inc., are capable of reducing such air-liquid interfaces by pressurizing, with gas, onto the liner, as opposed to directly onto the liquid in the container, while dispensing. Additionally, such containers have greater recyclability, as the retained liquids only contact the collapsible liner, thereby leaving the “firm overpack” available for reuse with another liner. However, known liners may be unable to provide adequate protection against environmental conditions. For example, current liner-based containers may fail to protect the retained liquid against at least two sources of gases. One source of gas is that which remains located or trapped between folds of the liner. More specifically, because of the flexible nature of the liners, and the potential for misfit with the outer container, interstitial air may become entrained within the folds of the collapsible liner. A second source of gas is that which is located between plys of a multi-ply liner. Such interstitial gas between folds of the liner or between multiple plys of the liner may contaminate the retained liquids over time, as the gas will be permitted to go into the solution and come out onto the wafer as a bubble or particle.

Additionally, containers with misfitting collapsible liners can be affected by vibrations during transportation, increasing particle generation in the liquids through undesired jostling. Such liners also may generate pinholes at low levels because of the vibrations during transportation.

Thus, there exists a need in the art for an efficient method of manufacturing a liner for an overpack, bottle, container, etc. that does not include the disadvantages presented by prior rigid-wall and collapsible liner-based containers and has a low degree of waste during liner production. There is a need in the art for a flexible liner that better conforms to the interior of the overpack, container, bottle, etc. There is a need in the art for a liner-based storage and dispensing system that addresses the problems associated with interstitial gas between folds of the liner and between multiple plys of the liner. There is a further need in the art for a flexible liner with lower transportation induced failures. There is yet a further need in the art for a fluoropolymer barrier liner with an integrated fitment port to ensure the purity of ultrapure liquids contained therein.

### BRIEF SUMMARY OF THE INVENTION

The present invention, in one embodiment, is a method for manufacturing a liner for an overpack. The method includes providing a polymeric liner preform, expanding the preform to substantially conform to a mold die, and collapsing the liner for insertion into an overpack. Providing a liner preform, in some embodiments, may include injecting one or more polymeric materials into a preform mold die to form a preform. Expanding the preform may include blow molding or stretch blow molding the preform to the dimensions of the overpack to form the liner. In alternative embodiments, the liner may be blow molded or stretch blow molded directly into the overpack. In certain embodiments, the method further includes heating the preform prior to blow molding the preform and testing the liner for leaks. A fluoropolymer may be used for the preform.

In another embodiment, a further method of manufacturing a flexible liner for a container is provided. The method includes providing a fluoropolymer preform, heating the fluoropolymer preform, and expanding the fluoropolymer preform to the dimensions of the overpack to form the flexible liner.

In a further embodiment, a flexible liner for an overpack is provided. The liner comprises a flexible body that substantially conforms to the interior of the overpack and a fitment port integral with the flexible body. The flexible body may be adapted to be removably inserted into the overpack by collapsing the flexible body, inserting the flexible body into the overpack, and re-inflating the flexible body inside the overpack. The flexible body may preferably comprise a fluoropolymer and may comprise multiple layers. The flexible body may further preferably comprise a gas barrier layer. The liner may be free-form and may be independent of the overpack. The liner, in some embodiments, may conform to the interior of the overpack without being adhesively bonded to the overpack.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a side, cross-sectional view of a flexible liner in accordance with an embodiment of the present disclosure positioned within an overpack.

FIG. 2 is a flow diagram of a method for manufacturing a flexible liner in accordance with an embodiment of the present disclosure.

FIG. 3A is a side, cross-sectional view of an injection step of a process of injection stretch blow molding a flexible liner, wherein a liner preform is fabricated in accordance with an embodiment of the present disclosure.

FIG. 3B is a side, cross-sectional view of an injection step of a process of injection stretch blow molding a flexible liner in accordance with an embodiment of the present disclosure, wherein a liner preform is removed from a preform mold.

FIG. 3C is a side, cross-sectional view of a preform conditioning step of a process of injection stretch blow molding a flexible liner in accordance with an embodiment of the present disclosure.

FIG. 3D is a side, cross-sectional view of a stretch blow molding step of a process of injection stretch blow molding a flexible liner in accordance with an embodiment of the present disclosure.

FIG. 3E is a side, cross-sectional view of another stretch blow molding step of a process of injection stretch blow molding a flexible liner in accordance with an embodiment of the present disclosure, wherein a liner preform is blown to the dimensions of a liner mold.

FIG. 4 is a side, cross-sectional view of a collapsed liner in accordance with an embodiment of the present disclosure.

FIG. 5 is a side, cross-sectional view of a collapsed liner in accordance with an embodiment of the present disclosure that is positioned within an overpack.

FIG. 6 is a side, cross-sectional view of a re-inflated liner in accordance with an embodiment of the present disclosure that is positioned within an overpack.

### DETAILED DESCRIPTION

The present disclosure relates to novel and advantageous liner-based storage and dispensing systems. Particularly, the present disclosure relates to novel and advantageous liners for use in overpacks, bottles, containers, etc. (hereinafter referred to collectively as “overpacks”) and methods for manufacturing such liners. More particularly, the present disclosure relates to flexible, injection blow molded or injection stretch blow molded liners for use in overpacks and methods for manufacturing the same that do not include the disadvantages presented by prior collapsible liner-based containers and have a low degree of waste during liner production. Unlike certain prior art liners that are formed by welding films together with resultant folds or seams, these three-dimensional (“3D”) liners better conform to the interior of the overpack and may lower transportation induced failures. Because folds in the flexible, 3D liner may be substantially eliminated, the flexible, 3D liners may substantially reduce or eliminate the problems associated with interstitial gas between folds of current liner-based containers. Similarly, because the flexible, 3D liner may be manufactured as a multilayer, single ply liner, the problems associated with interstitial gas between multiple plys of current liner-based containers may also be substantially eliminated. The flexible, 3D liners may be a fluoropolymer barrier liner with an integrated fitment port to ensure the purity of ultrapure liquids contained therein.

Example uses of such liners may include, but are not limited to, transporting and dispensing acids, solvents, bases, photoresists, dopants, inorganic, organic, and biological solutions, pharmaceuticals, and radioactive chemicals. However, such liners may further be used in other industries and for transporting and dispensing other products such as, but not limited to, soft drinks, cooking oils, agrochemicals, health and oral hygiene products, and toiletry products, etc. Those skilled in the art will recognize the benefits of such liners and the process of manufacturing the liners, and therefore will recognize the suitability of the liners to various industries and for the transportation and dispense of various products.

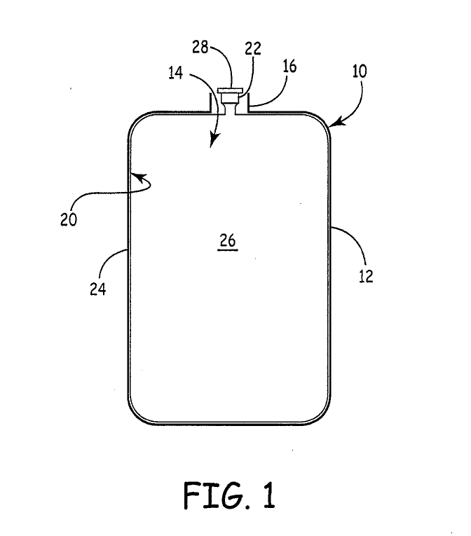

FIG. 1 illustrates a cross-sectional view of one embodiment of a flexible, 3D liner 20 of the present disclosure positioned within an overpack 10. The overpack 10 may include an overpack wall 12, an interior cavity 14, and a mouth 16. The overpack 10 may be manufactured using any process, such as injection blow molding, injection stretch blow molding, extrusion, etc. The overpack 10 may be manufactured as a single component or may be a combination of multiple components. In some embodiments, the overpack 10 may have a relatively simplistic design with a generally smooth overpack wall 12 and interior cavity 14. In other embodiments, the overpack 10 may have a relatively complicated design including, for example and not limited to, indentations, protrusions, and/or varying wall 12 thicknesses. An overpack having any dimensions or shape may be used with the flexible, 3D liner 20 of the present disclosure. In further embodiments, the overpack 10 may be substantially rigid, such that the overpack 10 is self-supporting. In other embodiments, the overpack 10 may be less rigid and require a support structure.

In further embodiments, the overpack 10 may have a fluid inlet for pressure dispensing of the contents of the liner. The fluid inlet may be a separate port, opening, stem, etc. that allows fluid or air or other gas to be introduced into the cavity 14 of the overpack 10. The fluid may be introduced through the separate fluid inlet or through a connector having a fluid passage, such connector being introduced into the mouth 16 of the overpack 10. The fluid may be delivered between the overpack wall 12 and the liner 20 to facilitate dispensing of the contents in the liner 20. Where the fluid includes a gas, the liner, preferably (as described further below), includes a barrier layer to prevent the gas from passing through the liner 20 and into the contents therein.

Liner 20 may include a liner wall 24, an interior cavity 26, and a mouth 28. Liner 20, in one embodiment, may be dimensioned and shaped to substantially conform to the interior of the overpack 10. As such, the liner 20 may have a relatively simplistic design with a generally smooth outer surface, or the liner 20 may have a relatively complicated design including, for example and not limited to, indentations and protrusions. The liner 20 may have a relatively thin liner wall 24, as compared to the thickness of the overpack wall 12. For example, in certain embodiments, the liner 20 may preferably have a thickness of between 1 and 10 mil. However, any suitable liner thickness may be used for the liner 20 of the present disclosure, including less than 1 mil or greater than 10 mil. The liner 20 is preferably flexible such that the liner wall 24 may be readily collapsed, such as by vacuum. This allows easy insertion of the liner 20 into an overpack 10. The flexibility further allows the liner wall 24 to be re-inflated upon insertion into an overpack 10. The liner 20 may be collapsed and re-inflated without damage to the liner wall 24. The liner wall 24 may re-inflate to substantially the dimensions and shape of the interior of the overpack 10. Thus, the liner 20 may be inflated, or re-inflated, to substantially conform to the interior of the overpack 10.

The liner 20, in a further embodiment, may have a shape, when inflated or filled, that is different from, but complimentary with, the shape of the overpack 10 such that it may be disposed therein. This liner may be called, or referred to herein, as a “free-form liner.” The liner 20 may also be removable or removably attached to the interior of the overpack wall 12. The liner wall 24 need not be adhesively bonded, or otherwise bonded, to the overpack wall 12. However, in some embodiments, the liner wall 24 can be adhesively bonded to the overpack wall 12 without departing from the spirit and scope of the present disclosure. Bonding the liner wall 24 to the overpack wall 12 can prevent the concept of “choking off” of the liner, where the liner collapses onto itself due to the liquid dispense and prevents the full use of the contents therein.

The liner 20 may provide a barrier, such as a gas barrier, against drive gas migration from the space between the liner wall 24 and the overpack wall 12. In some embodiments, the liner 20 may be manufactured using one or more polymers, including plastics, nylons, EVOH, polyolefins, or other natural or synthetic polymers. In a further embodiment, the liner 20 may be manufactured using a fluoropolymer, such as but not limited to, polychlorotrifluoroethylene (PCTFE), polytetrafluoroethylene (PTFE), fluorinated ethylene propylene (FEP), and perfluoroalkoxy (PFA). In some embodiments, the liner 20 may comprise multiple layers. For example, in certain embodiments, the liner 20 may include an internal surface layer, a core layer, and an outer layer, or any other suitable number of layers. The multiple layers may comprise one or more different polymers or other suitable materials. For example, the internal surface layer may be manufactured using a fluoropolymer (e.g., PCTFE, PTFE, FEP, PFA, etc.) and the core layer may be a gas barrier layer manufactured using such materials as nylon, EVOH, polyethylene naphthalate (PEN), PCTFE, etc. The outer layer may also be manufactured using any variety of suitable materials and may depend on the materials selected for the internal surface layer and core layer.

In accordance with the present methods, the liner 20 may be manufactured as a unitary component, thereby eliminating welds and seams in the liner and issues associated with welds and seams. For example, welds and seams may complicate the manufacturing process and weaken the liner. In addition, certain materials, which are otherwise preferable for use in certain liners, are not amenable to welding.

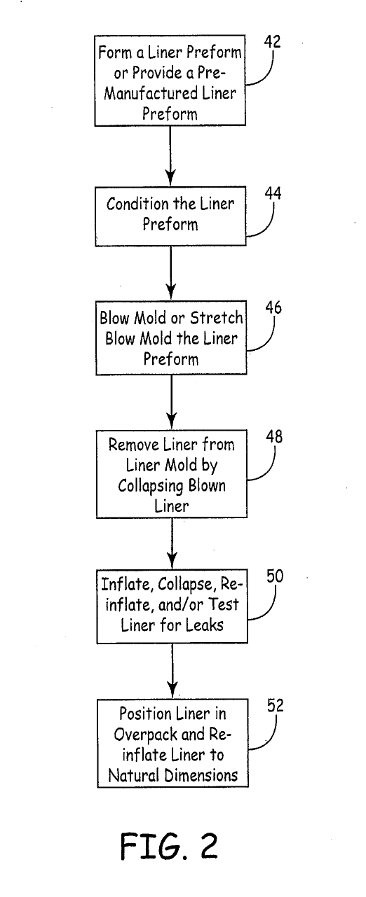

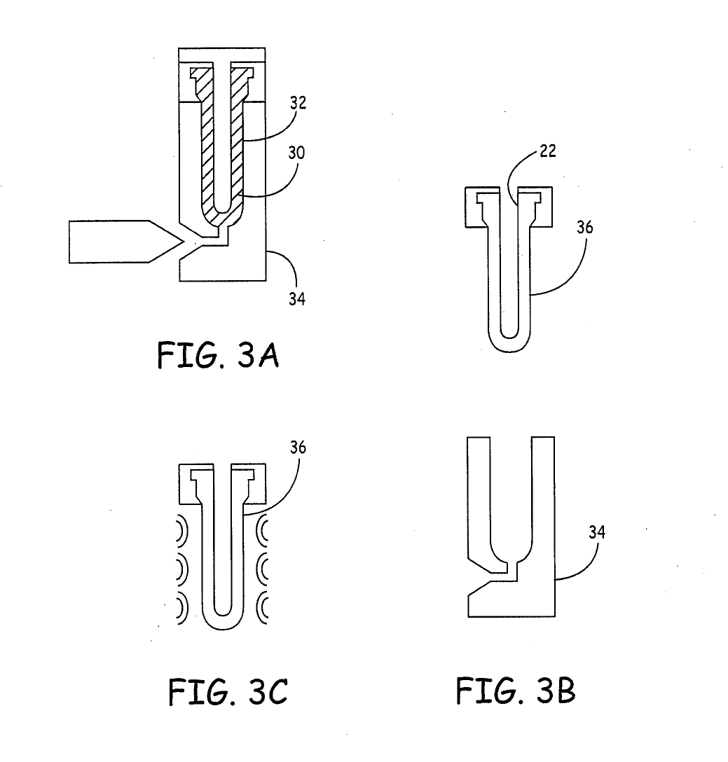

The liner 20 can be manufactured using any suitable manufacturing process, such as injection blow molding, injection stretch blow molding, etc. A manufacturing process utilizing injection blow molding or injection stretch blow molding can allow for liners to have more accurate shapes than other manufacturing processes. One exemplary embodiment for manufacturing the liner 20 using injection stretch blow molding is described with reference to the flow diagram of FIG. 2 and is further illustrated in FIGS. 3A-3E. It is recognized that not all steps of the exemplary embodiment for manufacturing the liner 20 shown in FIG. 2 are required, and some steps may be eliminated or additional steps may be added without departing from the spirit and scope of the present disclosure. The method may include forming a liner preform 36 (step 42) by injecting a molten form 30 of a polymer, or fluoropolymer, into an injection cavity 32 of a preform mold die 34. The mold temperature and the length of time in the mold may depend on the material or materials selected for manufacturing the liner preform 36. In some embodiments, multiple injection techniques may be used to form a preform 36 having multiple layers. The injection cavity 32 may have a shape that corresponds to a liner preform 36 (FIG. 3B) with integral fitment port 22. The polymer, or fluoropolymer, may solidify, and the resultant liner preform 36 may be removed from the preform mold die 34. In alternative embodiments, a pre-manufactured perform, including a multilayer preform, can be used for the preform 36 of the present disclosure.

In some embodiments, the liner preform 36 may be cleaned and heated to condition the liner preform 36 (step 44) prior to stretch blow molding, as illustrated in FIG. 3C. The liner preform 36, as illustrated in FIG. 3D, may then be inserted into a liner mold 38 having substantially a negative image of the interior of the overpack 10. The liner preform 36 may then be blown, or stretched and blown (step 46), to the image of the liner mold 38, as illustrated in FIG. 3E, to form the liner 20 having an integral fitment port 22. In other embodiments, the liner preform 36 may be blow molded, or stretch blow molded, in the overpack 10 itself to form the liner 20 inside the overpack 10. The blow molding air speed, as well as the blow molding temperature and pressure, may depend on the material selected for manufacturing the liner preform 36.

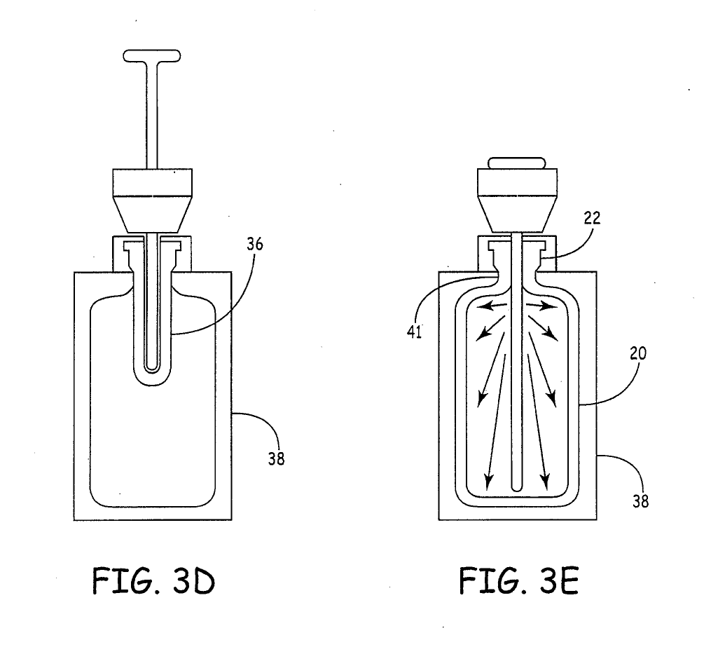

Once blown or stretch blown to the image of the liner mold 38, the liner 20 may solidify and be removed from the liner mold 38. In one embodiment, the liner 20 may be removed from the liner mold 38 by collapsing the liner wall 24, such as by vacuum collapsing, so that the collapsed liner 40, as shown in FIG. 4, may be removed from the liner mold 38 (step 48) through a mouth 42 of the liner mold 38, without separating the liner mold 38 into two or more separate mold components. The amount of vacuum pressure used to collapse the liner 20 may vary depending on the material or materials used, and the thickness thereof, for the liner 20. As such, in one embodiment, mold lines may be eliminated from the liner wall 24. In other embodiments, the liner 20 may be removed from the liner mold 38 by any suitable method. The liner 20, or collapsed liner 40, may be inflated, re-inflated, collapsed, and tested for leaks any suitable number of times (step 50). The liner 20, or collapsed liner 40, may be inflated, re-inflated, collapsed, and tested for leaks inside the liner mold 38, inside the overpack 10, or outside either the liner mold 38 or overpack 10.

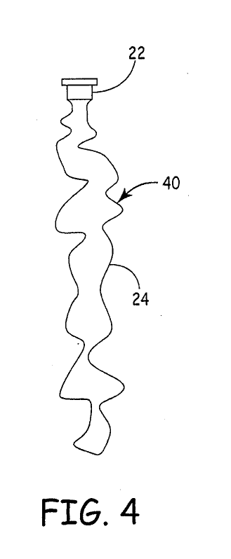

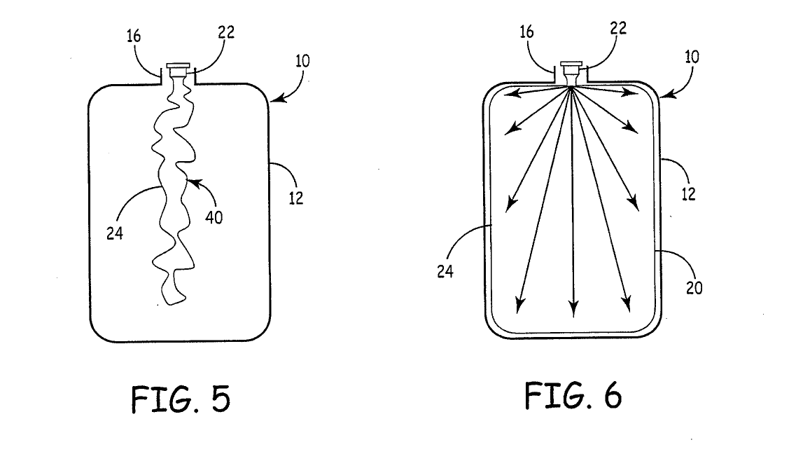

In a further embodiment, after the liner 20, or collapsed liner 40, has been removed from the liner mold 38 (e.g., where the liner is not blown directly into the overpack 10), the collapsed liner 40 (liner 20 may be collapsed if not done prior to removal from the liner mold 38) may be positioned within the overpack 10, as illustrated in FIG. 5. Once positioned in the overpack 10, the collapsed liner 40 may be re-inflated to its natural dimensions (step 52), which are substantially the negative image of the overpack 10, as illustrated in FIG. 6. The liner 20 may therefore be restored to its 3D form that substantially conforms to the interior of the overpack 10.

In some embodiments, because the liner 20 may conform substantially to the interior of the overpack 10, the overpack 10 may generally bear a portion of, or substantially all of, the load of the contents of the liner 20 during transportation of the liner 20 and overpack 10. That is, the overpack 10 may be substantially rigid or semi-rigid, such that the liner, being substantially conformed to the interior of the overpack 10, may transfer a portion of, or substantially all of, the load of the contents of the liner 20 to the overpack 10. As such, the liner 20 may bear a lesser load, and stress on the liner 20 may be minimized, thereby reducing the potential for transportation induced liner leakage.

In use, the liner 20, inside the overpack 10, may be filled with, or contain, an ultrapure liquid, such as an acid, solvent, base, photoresist, dopant, inorganic, organic, or biological solution, pharmaceutical, or radioactive chemical. It is also recognized that the liner 20 may be filled with other products, such as but not limited to, soft drinks, cooking oils, agrochemicals, health and oral hygiene products, and toiletry products, etc. The contents may be sealed under pressure, if desired. When it is desired to dispense the contents of the liner 20, the contents may be removed through the mouth 28 of the liner and the mouth 14 of the overpack 10, and the liner 20 may collapse upon emptying of the contents. As described above, a gas inlet 18 may allow air into the overpack 10 between the liner wall 24 and the overpack wall 12 to aid in the dispensing of the contents of the liner 20. In further embodiments, a fluid or gas line may be attached to the gas inlet 18, and a drive fluid or drive gas may be used to collapse the liner 20 and dispense the contents of the liner 20. If desired, the collapsed liner 40 may be removed from the overpack 10. The used collapsed liner 40 may then be disposed.

Although the present invention has been described with reference to preferred embodiments, persons skilled in the art will recognize that changes may be made in form and detail without departing from the spirit and scope of the invention.

1. A method for manufacturing a liner for an overpack comprising:
providing a polymeric liner preform;
expanding the preform to substantially conform to a mold die to form the liner; and
collapsing the liner for insertion into an overpack.

2. The method of claim 1, further comprising:
positioning the liner in an overpack; and
inflating the liner inside the overpack.

3. The method of claim 1, wherein the mold die has a negative image of the overpack.

4. The method of claim 1, wherein the step of providing the liner preform includes injection molding a polymeric material to form a liner preform.

5. The method of claim 4, wherein the step of providing the liner preform comprises providing a multilayer preform.

6. The method of claim 1, wherein the liner preform comprises a polymer acting as a gas barrier.

7. The method of claim 5, wherein the multilayer preform comprises an integrated gas barrier layer.

8. The method of claim 4, wherein the liner preform is provided with an integral fitment port.

9. The method of claim 1, wherein the step of expanding the preform includes blow molding the preform.

10. The method of claim 9, further comprising heating the preform prior to blow molding the preform.

11. The method of claim 1, further comprising a step of testing the liner for leaks prior to the collapsing step.

12. The method of claim 4, wherein the polymeric material comprises a fluoropolymer.

13. The method of claim 2, wherein the liner is inflated to substantially conform to the interior of the overpack.

14. The method of claim 9, wherein blow molding the preform comprises stretch blow molding the preform.

15. A method of manufacturing a flexible liner for an overpack comprising:
providing a fluoropolymer liner preform;
heating the preform; and
expanding the preform to substantially the dimensions of an overpack to form the liner.

16. The method of claim 15, further comprising:
collapsing the liner for insertion in an overpack;
positioning the liner in the overpack; and
inflating the liner inside the overpack.

17. The method of claim 15, wherein the step of providing a fluoropolymer preform includes injection molding a fluoropolymer material.

18. The method of claim 17, wherein the step of providing a fluoropolymer liner preform comprises providing a multilayer preform.

19. The method of claim 15, wherein the liner preform comprises a fluoropolymer acting as a gas barrier.

20. The method of claim 18, wherein the multilayer preform comprises an integrated gas barrier layer.

21. The method of claim 17, wherein the fluoropolymer liner preform is provided with an integral fitment port.

22. The method of claim 15, wherein the step of expanding the preform includes blow molding the fluoropolymer liner preform.

23. The method of claim 22, wherein blow molding the fluoropolymer liner preform is performed in the overpack.

24. The method of claim 15, wherein the liner has substantially thin walls, such that the liner is collapsible and re-inflatable.

25. The method of claim 24, wherein the liner is re-inflatable to substantially conform to the interior of the overpack.

26. The method of claim 22, wherein blow molding the fluoropolymer preform comprises stretch blow molding the fluoropolymer preform.

27. A flexible liner for an overpack, the liner comprising:
a flexible body that substantially conforms to the interior of the overpack; and
a fitment port integral with the flexible body;
wherein the flexible body is adapted to be removably inserted into the overpack and re-inflated inside the overpack.

28. The flexible liner of claim 27, wherein the flexible body comprises a fluoropolymer.

29. The flexible liner of claim 27, wherein the flexible body comprises multiple layers.

30. The flexible liner of claim 28, wherein the flexible body comprises a fluoropolymer acting as a gas barrier.

31. The flexible liner of claim 29, wherein the flexible body comprises an integrated gas barrier layer.

32. The flexible liner of claim 29, wherein the multiple layers comprise more than one material.

33. The flexible liner of claim 27, wherein the liner is a free-form liner.

34. The flexible liner of claim 27, wherein the liner is substantially free of mold lines.

35. The flexible liner of claim 27, wherein the liner is formed by:
providing a polymeric liner preform; and
expanding the preform to substantially conform to a mold die having a negative image of the overpack to form the liner;
such that the liner is formed as a unitary component.

36. A liner-based storage and dispensing system comprising a flexible liner and an overpack and manufactured by:
expanding a polymeric liner preform to substantially conform to a mold die to form the flexible liner;
collapsing the flexible liner for insertion into the overpack;
positioning the liner in the overpack; and
inflating the liner inside the overpack.

37. The liner-based storage and dispensing system of claim 36, wherein the mold die has a negative image of the overpack.

38. The liner-based storage and dispensing system of claim 36, wherein the flexible liner comprises a gas barrier.

39. The liner-based storage and dispensing system of claim 36, wherein the step of expanding the liner preform includes blow molding the liner preform.

40. The liner-based storage and dispensing system of claim 39, wherein blow molding the liner preform includes stretch blow molding the liner preform.
